(19) United States
(12) Patent Application Publication
(10) Pub. No.: US 2004/0119297 A1
(43) Pub. Date: Jun. 24, 2004

(54) Push-push sliding cosmetic container

(76) Inventors: Joseph J. Bella, Forest Park, IL (US); Steven L. Bivens, Kankakee, IL (US)

Correspondence Address: PAUL F. DONOVAN, ILLINOIS TOOL WORKS INC., 3600 WEST LAKE AVENUE, GLENVEIW, IL, 60025, US

(21) Appl. No.: 10/665,704

(22) Filed: Sep. 19, 2003

Related U.S. Application Data
(60) Provisional application No. 60/436,272, filed on Dec. 24, 2002.

(51) Int. Cl. E05C 19/00

(52) U.S. Cl. 292/300

(57) ABSTRACT

A cosmetic container includes a drawer slidable into a pocket. A push-to-latch, push-to-unlatch latch mechanism is provided on the drawer and pocket.

### CROSS REFERENCE TO RELATED APPLICATIONS

The present regular United States Patent Application claims benefits of U.S. Provisional application 60/436,272, filed Dec. 24, 2002.

### FIELD OF THE INVENTION

The present invention relates generally to latch mechanisms used with openable objects, and more particularly to thin profile latch mechanisms used between relatively axially translatable objects such as cosmetic containers and the like.

### BACKGROUND OF THE INVENTION

Openable objects have used a wide variety of latch mechanisms or closure members often also associated with a hinge connection between the members. For example, cosmetic and or other containers are known to include a cover and a box-like compartment connected by one or more hinges. Latch components on the cover and compartment are engaged or disengaged to latch or unlatch the container. A twisting or prying motion is often used to unlatch the components. A disadvantage of such an arrangement is that when unlatched, the cover is freely moveable about the hinge relative to the compartment. The container is easily opened accidentally, which can result in the contents spilling from the container. In cosmetic cases, accidental spilling of the contents can be quite messy, contaminating individuals and things coming in contact therewith.

Other configurations of containers and other types of latch mechanisms also have been used. For example, it is known to provide the container portion of such a case as a drawer slidable in a sleeve. The sleeve can include a top, possibly a bottom or bottom portion, opposed sides and one end panel, with the opposite end being open. The box-like structure has four walls and a base, and is slidable into the sleeve. Detent and other latch arrangements between the box and sleeve have been used to secure the container in a closed condition. Often the detent type latch mechanisms are difficult to operate, and the acts of opening or closing can cause jarring or jostling of the contents in the box-like structure, potentially resulting in a spill of the contents.

Cosmetic containers often are small, holding only a small volume of material, which is used only in small amounts. Frequently, the cases therefor are very thin, to fit easily in purses, pockets and other convenient carrying locations. The nature of the container complicates designing latches therefor, as it is difficult to form a suitable latch that is easy to install and operate, yet is secure when closed on the thin types of containers frequently used for cosmetics.

What is needed in the art is a simple to operate yet secure latch mechanism that can be incorporated in a container arrangement minimizing the potential for spilling contents if the latch is inadvertently unlatched or not properly latched. For use in cosmetic containers or other structures that are typically relatively small, being both narrow and thin, the latch mechanism should operate in a small environment. Containers for cosmetics and other consumables typically are not reused and are disposable. It is therefore desirable that the container is inexpensive to manufacture, and the latch mechanism should not add significantly to the manufacturing cost of the container.

### SUMMARY OF THE INVENTION

The present invention provides a cosmetic container with a pocket and a drawer slidable into and out of the pocket. A push-to-latch, push-to-unlatch mechanism is provided having components on the pocket and the drawer, with an entrance path, an exit path and a latching nest therebetween in the pocket, and a follower movable through the tracks and into and out of the nest provided on the drawer.

In one aspect thereof, the present invention provides a container with a pocket, and a drawer slidable relative to the pocket in an axial direction between a closed position within the pocket and an opened position at least partly out of the pocket. A latch mechanism has a first latch component on the pocket and a second latch component on the drawer. One of the latch components is a track component including a nest, an entrance track leading to the nest, an exit track from the nest and a redirector associated with the nest and the tracks. The other of the latch components is a follower movable along the tracks and movable into and out of the nest upon transition from the entrance track to the exit track. One of the latch components is substantially fixed relative to the pocket or the drawer that it is on, and the other of the latch components is translatable transverse to the axial direction with respect to he pocket or the drawer that it is on.

In another aspect thereof, the present invention provides a cosmetic container with a pocket having a bottom, a top, opposed sides between the bottom and the top and an end. The pocket also has an open end. A drawer defines at least one compartment for holding a cosmetic. The drawer is slidable in an axial direction relative to the pocket between an opened position in which the drawer is at least partly exposed out of the pocket and a closed position in which the drawer is contained in the pocket. A latch mechanism has a first latch component on the pocket and a second latch component on the drawer. One of the latch components is a track component including a wall defining a substantially enclosed space, with a portal in the wall and a nest in the space. The nest defines a notch. An entrance track is provided from the portal to the nest, and an exit track from the nest to the portal. A redirector is associated with the nest and the tracks. The latch component that is not the track component is a follower movable along the tracks and guided by the redirector to move into and out of the notch upon transition from the entrance track to the exit track. One of the latch components is substantially fixed relative to the pocket or drawer that it is on, and the other of the latch components is translatable transverse to the axial direction with respect to the pocket or the drawer that it is on.

In still another aspect thereof, the present invention provides a method for closing, latching, unlatching and opening a cosmetic container with steps of providing a pocket and a drawer slidable into the pocket; providing a push-to-latch, push-to-unlatch latch mechanism including a first component on the pocket and a second component on the drawer; inserting the drawer into the pocket;

pushing the drawer to a fully inserted position and releasing the drawer to latch the mechanism; and from a latched position pushing the drawer to a fully inserted position and releasing the drawer from the fully inserted position to unlatch the mechanism.

An advantage of the present invention is providing a cosmetic container having a push-to-latch and push-to-unlatch mechanism that operates smoothly and easily for both opening and closing of the container.

Another advantage of the present invention is providing a container that is easy to latch and unlatch yet remains securely closed when latched.

Yet another advantage of the present invention is providing a secure latch mechanism for a container which is easily manufactured at minimal increased cost.

A further advantage of the present invention is providing a latch mechanism for a thin, narrow container on which the latch mechanism is concealed to provide a smooth, elegant appearance for the container.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a cosmetic container in accordance with the present invention, with the container being shown in an opened position;

FIG. 2 is a perspective view of the cosmetic container shown in FIG. 1, but illustrating the container in a closed position;

FIG. 3 is a plan view of the opened cosmetic container, showing the latch mechanism from the underside thereof;

FIG. 4 is an exploded view of the cosmetic container;

FIG. 5 is a fragmentary view illustrating the latch mechanism being moved from an opened position toward a closed position;

FIG. 6 is a fragmentary view similar to FIG. 5, but illustrating the latch mechanism in the latched position with the container closed; and

FIG. 7 is a fragmentary view similar to FIGS. 5 and 6, but illustrating the latch mechanism moving from the closed position toward the opened position.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

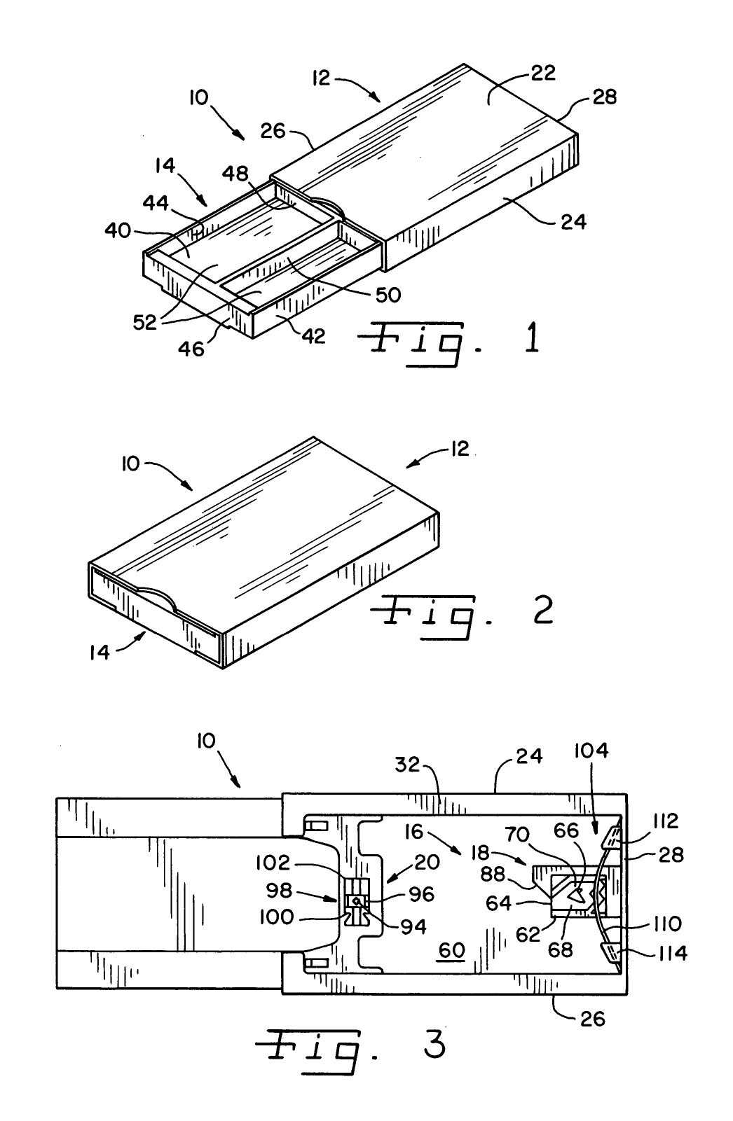

Referring now more specifically to the drawings and to FIG. 1 in particular, a cosmetic case or container 10 is shown in accordance with the present invention. Cosmetic container 10 includes a pocket 12 and a drawer 14. A latch mechanism 16 (FIG. 3) is operatively associated between pocket 12 and drawer 14. Latch mechanism 16 includes a first latch component 18 on pocket 12 and a second latch component 20 on drawer 14. Container 10 can be made of plastic, and can be made in various sizes and shapes, as needed. Further, while described herein as a cosmetic container, it should be understood that the principles of the present invention can be used for containers to hold items and things other than cosmetics as well.

Pocket 12 includes a top 22, first and second opposed sides 24 and 26 and an end 28. An opposite end 30 from end 28 is open for receiving drawer 14. A bottom 32 is provided, which may be partial segments along each side 24 and 26 as illustrated in FIG. 3, or a fully extensive bottom similar to top 22.

Drawer 14 includes a drawer bottom 40, side walls 42 and 44, a front 46 and a back 48. One or more intermediate walls 50 can be provided between sidewalls 42 and 44 or between front 46 and back 48, one such intermediate wall 50 being shown in FIG. 1 disposed between front 46 and back wall 48. Front 46, back 48, sidewalls 42, 44 and intermediate walls 50, if any, define one or more compartments 52, two such compartments 52 being illustrated in FIG. 1. Compartments 52 can be filled with cosmetic substances or other things. For example, one compartment 52 can be used for holding the cosmetic, and another compartment 52 can be used for holding a suitable applicator for the cosmetic.

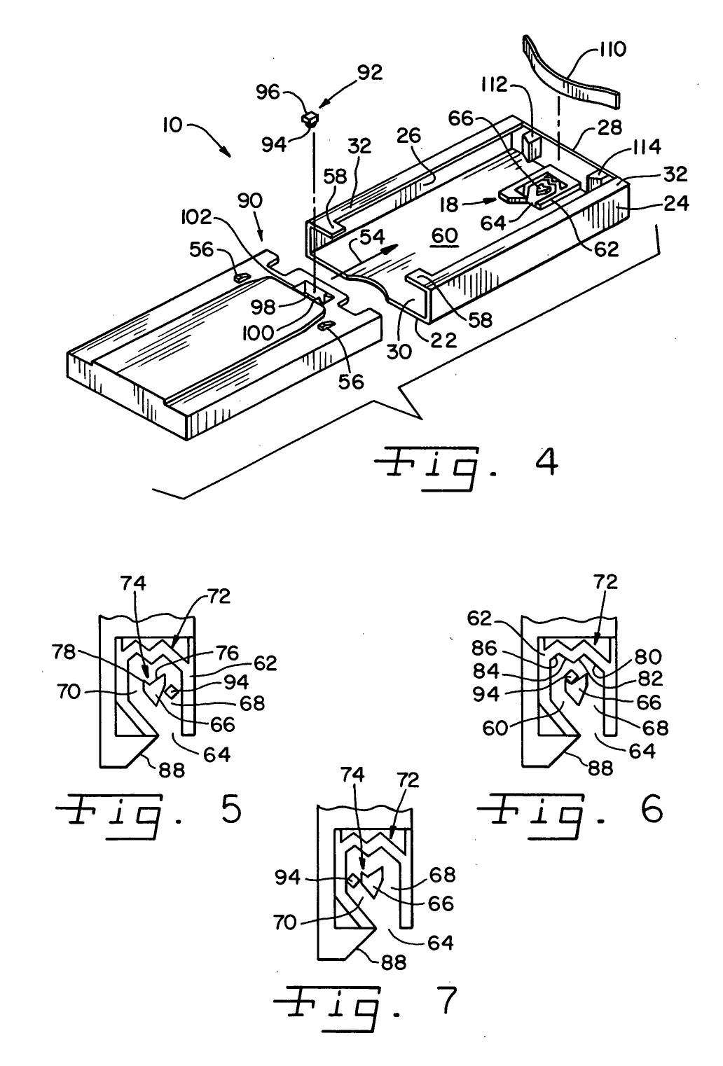

Pocket 12 and drawer 14 can be formed inexpensively from molded plastic or the like. Drawer 14 is sufficiently smaller than the open area defined by pocket 12 to be slidable between an opened position shown in FIG. 1 and a closed position shown in FIG. 2. In the opened position, at least a portion of drawer 14 is exposed; whereas in the closed position illustrated in FIG. 2, drawer 14 is contained within pocket 12. Relative axial movement between pocket 12 and drawer 14, as illustrated by arrow 54 in FIG. 4, moves the components to the opened or closed positions as illustrated. One or more protrusion 56 on the bottom of drawer 14 can be used to engage one or more lip 58 on bottom 32, to function as a stop inhibiting drawing 14 from sliding completely from pocket 12. Two such protrusions 56 and two lips 58 are shown in the exemplary embodiment. Such drawer and pocket arrangements are known to those skilled in the art, and will not be described in further detail herein.

First latch component 18 is a substantially fixed component disposed on an inner surface 60 of top 22. First latch component 18 is seen best in FIGS. 5-7, wherein, for clarity, the reference numerals for some components are shown in less than all of the drawings, even though the same components are present in all of FIGS. 5-7. First latch component 18 includes a somewhat heart shaped wall 62 defining a substantially enclosed space except for a single opening or portal 64 provided therein. Within the area confined by wall 62, a shaped nest 66 is provided. Together with nest 66, and specifically the outer surface thereof, wall 62 defines an entrance track 68 and an exit track 70 leading from and toward portal 64, respectively. A redirector 72 is provided between portions of wall 62 defining entrance and exit tracks 68 and 70. Redirector 72 is operatively positioned with respect to nest 66 to effect latching and unlatching as will be described subsequently herein.

Nest 66 (FIG. 5) is a substantially solid body defining a notch 74 facing redirector 72. Notch 74 has a longer entrance surface 76 and a somewhat shorter exit surface 78, which together form notch 74.

Redirector 72 (FIG. 6) is a somewhat flattened M-shaped segment of wall 62, with an inner tip or point thereof directed at notch 74 on the inner perimeter of wall 62. Redirector 72 includes an entrance surface 80, a latch-directing surface 82, an unlatch-directing surface 84 and an exit surface 86.

A guide surface 88 is provided at portal 64, to ensure smooth entry of second latch component 18 into first latch component 16, as will be described subsequently herein.

Second latch component 20 is provided at an inner end 90 of drawer 14. Second latch component 20 includes a follower 92 substantially fixed in an axial direction relative to drawer 14, but translatable in a direction transverse to the axial direction. Thus, follower 92 includes a pin 96 on a sled 96 contained in and slidable along a slot 98. Follower 92 is freely movable along slot 98, from one end 100 of slot 98 to the opposite end 102 thereof.

A biasing mechanism 104 is provided on end 28, and includes a leaf spring 110 secured to anchor blocks 112 and 114 on opposite ends thereof. Leaf spring 110 extends over first latch component 18 to engage inner end 90 of drawer 14.

With drawer 14 positioned in pocket 12, one end 100 of slot 98 is substantially aligned with portal 64 such that, with sled 96 positioned substantially adjacent slot end 100, pin 94 will enter portal 64 as drawer 14 is slid into pocket 12. Guide surface 88 adjacent portal 64 is angularly disposed relative to the axial direction of pocket 12. If sled 96 is positioned away from slot end 100, toward slot end 102, pin 94 will encounter and slide along guide surface 88, moving follower 92 toward slot end 100 so that pin 94 will enter portal 64. Thus, regardless of the initial position of follower 92 as drawer 14 is slid into pocket 12, pin 94 will enter portal 64 and move along entrance track 62. The incoming position is illustrated in FIG. 5.

With further relative axial movement of drawer 14 with respect to pocket 12, pin 94 advances along entrance track 62 until it encounters entrance surface 80 of redirector 92. With still further axial inward movement of drawer 14, follower 92 slides along entrance surface 80, thus moving sled 96 away from slot end 100. As drawer 14 reaches the fully inserted position, inner end 90 encounters and compresses leaf spring 110, and pin 94 encounters latch directing surface 82. Since drawer 14 is then fully inserted, a user will naturally release drawer 14, terminating axially inward pressure on drawer 14. Leaf spring 110 urges drawer 14 outward slightly, causing pin 94 to slide along and off of latch directing face 82 to nest in notch 74. As pin 94 enters notch 74, pin 94 is directed therein also by entrance surface 76 of notch 74, which moves follower 92 still further toward slot end 92. With continued axially outward biasing force from spring 110, drawer 14 is held securely in pocket 12, with pin 94 nested in notch 74. The latched position of latch mechanism 16 is illustrated in FIG. 6. Outward force applied to drawer 14, by pulling or the like, will not dislodge pin 94 from notch 74.

To release latch mechanism 16 from the latched position and remove drawer 14, drawer 14 is pushed inward slightly. From the nested position within notch 74, pin 94 is moved outwardly toward redirector 72, encountering unlatch directing surface 84 and not latch directing surface 82 as a result of the slight transverse movement of follower 92 as it nested into notch 74. Sliding along unlatch directing surface 84, follower 92 moves transverse to the axial direction still further toward slot end 102, and pin 94 encounters exit surface 86. With just slight movement, drawer 14 is again fully inserted into pocket 12 such that it cannot be advanced further therein. Again, the natural tendency of the user is to release and terminate further inward pressure on drawer 14. Leaf spring 110 again moves drawer 14 outwardly when the inward pressure is released. Pin 94 follows along exit surface 86, and pin 94 enters exit track 70. The exit position is shown in FIG. 7. Force from spring 110 moves drawer 14 slightly out from pocket 12 so it can be grasped easily and pulled. Continued outward movement of drawer 14 causes pin 94 to exit from portal 64.

Thus, a simple push-to-latch and push-to-unlatch container is provided. Tracks 68 and 70 can be relatively shallow and pin 94 relatively short so that latch mechanism 16 does not add significantly to the thickness of container 10.

It should be understood that the various parts and components can be reversed. In its simple form, latch mechanism 16 includes first and second components on pocket 12 and drawer 14, respectively. One of the latch components is a track component, first latch component 18 on pocket 12 in the exemplary embodiment. The other of the latch components includes a follower movable relative to the tracks, second latch component 20 on drawer 14 in the exemplary embodiment. However, it should be understood that the latch components can be reversed with the substantially fixed component being on drawer 14 and the latch component translatable transverse to the axial direction positioned on pocket 12. Still other variations and modifications are possible.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A container comprising:
a pocket;
a drawer slidable relative to said pocket in an axial direction between a closed position within said pocket and an opened position at least partly out of said pocket; and
a latch mechanism having a first latch component on said pocket and a second latch component on said drawer;
one of said latch components being a track component including:
a nest;
an entrance track leading to said nest;
an exit track from said nest; and
a redirector associated with said nest and said tracks; and
the other of said latch components being a follower movable along said tracks and movable into and out of said nest upon transition from said entrance track to said exit track;
one of said latch components being substantially fixed relative to the one of said pocket and said drawer which it is on; and
the other of said latch components being translatable transverse to said axial direction with respect to the one of the said pocket and said drawer which it is on.

2. The container of claim 1, said follower being translatable transverse to said axial direction.

3. The container of claim 2, said follower being disposed on said drawer.

4. The container of claim 3, said drawer having an inner end and said follower disposed at said inner end.

5. The container of claim 1, said track component disposed in said pocket.

6. The container of claim 5, said track component being substantially fixed in position relative to said pocket.

7. The container of claim 6, said drawer having an inner end and said follower disposed at said inner end.

8. The container of claim 7, said pocket having a spring engaged by said drawer for urging said drawer outwardly from said pocket.

9. The container of claim 7, said track component including a guide leading into said entrance track.

10. The container of claim 7, said pocket having a top with an inner surface, and said track component disposed on said inner surface.

11. The container of claim 10, said drawer defining a slot transverse to said axial direction, and said follower disposed slidably in said slot.

12. A cosmetic container comprising:
a pocket having a bottom, a top, opposed sides between said bottom and said top and an end, said pocket having an open end;
a drawer defining at least one compartment for a cosmetic, said drawer being slidable in an axial direction relative to said pocket between an opened position in which said drawer is at least partly exposed out of said pocket and a closed position in which said drawer is contained in said pocket; and
a latch mechanism having a first latch component on said pocket and a second latch component on said drawer;
one of said latch components being a track component including a wall defining a substantially enclosed space with a portal in said wall, a nest in said space, said nest defining a notch, an entrance track from said portal to said nest, an exit track from said nest to said portal, and a redirector associated with said nest and said tracks; and
the other of said latch components being a follower movable along said tracks and guided by said redirector to move into and out of said notch upon transition from said entrance track to said exit track; and
one of said latch components being substantially fixed relative to the one of said pocket and said drawer which it is on; and the other of said latch components being translatable transverse to said axial direction with respect to the one of said pocket and said drawer which it is on.

13. The cosmetic container of claim 12, said follower being translatable transverse to said axial direction and being disposed on said drawer.

14. The cosmetic container of claim 13, said drawer having an inner end defining a slot, and said follower disposed for movement in said slot.

15. The cosmetic container of claim 14, said pocket having a spring engaged by said drawer for urging said drawer outwardly from said pocket.

16. The cosmetic container of claim 15, said track component including a guide leading into said entrance track.

17. The cosmetic container of claim 16, said pocket having a top with an inner surface, and said track component disposed on said inner surface.

18. The cosmetic container of claim 12, said redirector including a surface for guiding said follower into said notch from said entrance track, and a second surface for guiding said follower into said exit track from said notch.

19. A method for closing, latching, unlatching and opening a cosmetic container, comprising steps of:
providing a pocket and a drawer slidable into the pocket;
providing a push-to-latch, push-to-unlatch latch mechanism including a first component on the pocket and a second component on the drawer;
inserting the drawer into the pocket;
pushing the drawer to a fully inserted position and releasing the drawer to latch the mechanism; and
from a latched position pushing the drawer to a fully inserted position and releasing the drawer from the fully inserted position to unlatch the mechanism.

20. The method of claim 19, including pulling the drawer from the unlatched position to a fully opened position.
